(19) United States
(12) Patent Application Publication
(10) Pub. No.: US 2019/0185640 A1
(43) Pub. Date: Jun. 20, 2019

(54) RUBBER COMPOSITION, TRANSFER ROLLER, AND IMAGE FORMING APPARATUS

(71) Applicant: SUMITOMO RUBBER INDUSTRIES, LTD., Hyogo (JP)

(72) Inventors: Yusuke TANIO, Hyogo (JP); Keisuke OSAKA, Hyogo (JP)

(73) Assignee: SUMITOMO RUBBER INDUSTRIES, LTD., Hyogo (JP)

(21) Appl. No.: 16/163,573

(22) Filed: Oct. 18, 2018

(30) Foreign Application Priority Data
Dec. 19, 2017 (JP) 2017-242934

(51) Int. Cl. C08L 9/02; G03G 15/16; C08J 9/00; C08J 9/10

(52) U.S. Cl. CPC C08L 9/02; G03G 15/16; C08J 9/0061; C08J 9/0066; C08J 9/103; C08L 2205/03; C08J 2471/03; C08L 2312/00; C08J 2203/18; C08J 2203/04; C08J 2309/02; C08J 2409/06; C08J 2409/00; C08L 2205/025

(57) ABSTRACT

A rubber composition in which a transfer roller with lower resistance than in the related art is able to be formed without increasing a blending ratio of epichlorohydrin rubber, a transfer roller including the rubber composition, and an image forming apparatus having the transfer roller incorporated therein are provided. The rubber composition is obtained by blending rubbers including at least one of NBR, SBR, and BR and epichlorohydrin rubber with a crosslinking component, a foaming component, and 3 to 50 parts by mass aluminum silicate with respect to 100 parts by mass of the total amount of rubbers. A transfer roller includes a roller main body formed by extrusion-molding the rubber composition in a tubular shape and foaming and crosslinking the rubber composition. The image forming apparatus includes the transfer roller incorporated therein.

### CROSS-REFERENCE TO RELATED APPLICATION

This application claims the priority of Japan patent application serial no. 2017-242934, filed on Dec. 19, 2017. The entirety of the above-mentioned patent application is hereby incorporated by reference herein and made a part of this specification.

### BACKGROUND

### Technical Field

The disclosure relates to a rubber composition, a transfer roller formed using the rubber composition, and an image forming apparatus having the transfer roller incorporated therein.

### Description of Related Art

For example, in image forming apparatuses using electrophotographic methods such as laser printers, electrostatic copying machines, plain paper facsimile machines, and multifunctional machines thereof, with the market maturation in recent years, attempts to accomplish higher image quality and higher speeds have been in progress.

Also, the need to lower resistance of a transfer roller, which is one component constituting an image forming apparatus, in order to handle such capabilities has been increasing.

In the related art, as a transfer roller, for example, a transfer roller including a porous single-layer roller main body obtained by preparing a rubber composition including a diene-based rubber, an ionic conductive rubber, a crosslinking component, and a foaming component, forming the rubber composition in a tubular shape, and foaming and then crosslinking the rubber composition is known. Furthermore, as an ionic conductive rubber, epichlorohydrin rubber is generally used (Patent Document 1).

In order to decrease resistance of a transfer roller including a roller main body constituted of the above-described rubber composition compared with the related art, that is, reduce a roller resistance value, increasing a blending ratio of epichlorohydrin rubber as an ionic conductive rubber can be considered (Patent Document 2).

[Patent Document 1] Japanese Unexamined Patent Application Publication No. 2006-259131

[Patent Document 2] Japanese Unexamined Patent Application Publication No. H11-065269

Meanwhile, there is a problem that, when a blending ratio of epichlorohydrin rubber is increased, a component derived from the epichlorohydrin rubber transitions to a photoreceptor, a transfer belt, and the like, and contaminates these members and accordingly image defects are likely to occur in a formed image.

The disclosure provides a rubber composition in which a transfer roller with lower resistance than in the related art is able to be formed without increasing a blending ratio of epichlorohydrin rubber, a transfer roller including the rubber composition, and an image forming apparatus having the transfer roller incorporated therein.

### SUMMARY

The disclosure is a rubber composition including: at least one selected from the group consisting of acrylonitrile butadiene-based rubbers, styrene butadiene-based rubbers, and butadiene-based rubbers; a rubber including epichlorohydrin rubber; a crosslinking component configured to crosslink the rubbers; a foaming component configured to foam the rubbers; and 3 parts by mass or more and 50 parts by mass or less aluminum silicate with respect to 100 parts by mass of the total amount of rubbers.

Also, the disclosure is a transfer roller including the rubber composition.

In addition, the disclosure is an image forming apparatus having the transfer roller incorporated therein.

### BRIEF DESCRIPTION OF THE DRAWINGS

FIG. 1 is a perspective view illustrating an example of an embodiment of a transfer roller according to the disclosure.

FIG. 2 is a diagram for explaining a method for measuring a roller resistance value of the transfer roller.

### DESCRIPTION OF THE EMBODIMENTS

According to the disclosure, a rubber composition in which a transfer roller with lower resistance than in the related art is able to be formed without increasing a blending ratio of epichlorohydrin rubber, a transfer roller including the rubber composition, and an image forming apparatus having the transfer roller incorporated therein can be provided.

<<Rubber Composition>>

As described above, the disclosure is a rubber composition including at least one selected from the group consisting of acrylonitrile butadiene-based rubbers (NBRs), styrene butadiene-based rubbers (SBRs), and butadiene-based rubbers (BRs), a rubber including epichlorohydrin rubber, a crosslinking component configured to crosslink the rubbers, a foaming component configured to foam the rubbers, and 3 parts by mass or more and 50 parts by mass or less aluminum silicate with respect to 100 parts by mass of the total amount of rubbers.

According to the disclosure, it is possible to reduce a roller resistance value of a transfer roller to be lower than it currently is without increasing a blending ratio of epichlorohydrin rubber when aluminum silicate is blended with a rubber composition in the predetermined proportion.

<Aluminum Silicate>

Examples of aluminum silicate include various types of aluminum silicate derived from synthetic and natural products. Particularly, clay containing aluminum silicate as a main component is appropriately used in terms of easy availability or achievement of reduction in production cost.

It should be noted that clay is also described in Patent Documents 1 and 2 and is a well-known component as a filler for rubber compositions. However, the fact that aluminum silicate contained in clay has a function of decreasing a resistance value of a transfer roller and the fact that aluminum silicate contained in clay can decrease a roller resistance value of a transfer roller without increasing a blending ratio of epichlorohydrin rubber are not known. For this reason, for example, clay is also merely exemplified in Patent Documents 1 and 2 and an example in which effects are actually verified using clay is not included.

The reason why the blending ratio of aluminum silicate is limited to a range of 3 parts by mass or more and 50 parts by mass or less with respect to 100 parts by mass of the total amount of rubbers as described above is as follows.

That is to say, when the blending ratio of aluminum silicate is below this range, an effect of reducing the roller resistance value of the transfer roller without increasing the blending ratio of epichlorohydrin rubber described above due to the blending of aluminum silicate cannot be obtained.

On the other hand, when the blending ratio of aluminum silicate exceeds the above-described range, the crosslinked and foamed roller main body is too hard and thus the roller main body may not have suitable flexibility for the roller main body to be appropriately used as a transfer roller in some cases. Furthermore, the viscosity of a rubber composition before crosslinking at the time of heating and melting increases or the processability or the foamability of the rubber composition decreases in some cases.

On the other hand, when the blending ratio of aluminum silicate is set to the above-described range, it is possible to reduce a roller resistance value of the transfer roller without increasing the blending ratio of epichlorohydrin rubber while maintaining good flexibility of the roller main body or good processability and foamability of the rubber composition.

It should be noted that the blending ratio of aluminum silicate is preferably 45 parts by mass or less with respect to 100 parts by mass of the total amount of rubbers even in the above-described range in consideration of further improving these effects and the above-described blending ratio is a blending ratio of aluminum silicate itself contained in clay when the clay is blended.

<Rubbers>

Examples of the rubbers include a diene-based rubber of at least one type among three types of rubbers, i.e., NBRs, SBRs, and BRs, and epichlorohydrin rubber as described above.

Among these, diene-based rubbers function to impart good characteristics as rubbers, that is, good flexibility, low permanent compressive distortion, resistance to permanent settling, and the like, to the roller main body of the transfer roller.

(NBR)

NBRs have excellent functions as the above-described diene-based rubbers. Furthermore, since NBRs are polar rubber, NBRs also function to finely adjust a roller resistance of the transfer roller.

For this reason, it is desirable to use only NBRs or a combination of NBRs and SBRs or BRs as diene-based rubbers.

Examples of NBRs include any of low nitrile NBRs in which the content of acrylonitrile is 24% or less, medium nitrile NBRs in which the content of acrylonitrile is 25 to 30%, medium-high nitrile NBRs in which the content of acrylonitrile is 31 to 35%, high nitrile NBRs in which the content of acrylonitrile is 36 to 42%, and ultra-high nitrile NBRs in which the content of acrylonitrile is 43% or more.

Also, examples of NBRs include NBRs of an oil-extender type having adjusted flexibility due to added extender oil and NBRs of a non-oil-extender type having no added extender oil, but in the disclosure, it is desirable to use NBRs of a non-oil-extender type which do not contain extender oil which can be a bleeding substance to prevent contamination of a photoreceptor, a transfer belt, or the like.

One or two or more of these NBRs can be used.

(SBR)

Examples of SBRs include any of various SBRs obtained by copolymerizing and synthesizing styrene and 1,3-butadiene using various polymerization methods such as an emulsion polymerization method and a solution polymerization method.

Also, examples of SBRs include SBRs of a high styrene type, a medium styrene type, and a low styrene type classified in accordance with the content of styrene, and any of these can be used.

Also, examples of SBRs include SBRs of an oil-extender type having adjusted flexibility due to added extender oil and SBRs of a non-oil-extender type having no added extender oil, but in the disclosure, it is desirable to use SBRs of a non-oil-extender type which do not contain extender oil which can be a bleeding substance to prevent contamination of a photoreceptor, a transfer belt, or the like.

One or two or more of these SBRs can be used.

(BR)

Examples of BRs include any of various BRs in which a polybutadiene structure is included in molecules and which have crosslinking properties.

Particularly, high cis-BRs having a content of cis-1,4 bonding of 95% or more, which can exhibit good properties as rubbers in a wide temperature range from low temperatures to high temperatures, is desirable.

Also, examples of BRs include BRs of an oil-extender type having adjusted flexibility due to added extender oil and BRs of a non-oil-extender type having no added extender oil, but in the disclosure, it is desirable to use BRs of a non-oil-extender type which do not contain extender oil which can be a bleeding substance to prevent contamination of a photoreceptor, a transfer belt, or the like.

One or two or more of these BRs can be used.

(Epichlorohydrin Rubber)

Examples of epichlorohydrin rubber include various polymers which include epichlorohydrin as a repeating unit and have an ionic conductivity.

Examples of epichlorohydrin rubber include one or two or more polymers such as epichlorohydrin homopolymers, epichlorohydrin-ethylene oxide bipolymers (ECOs), epichlorohydrin-propylene oxide bipolymers, epichlorohydrin-allyl glycidyl ether bipolymers, epichlorohydrin-ethylene oxide-allyl glycidyl ether terpolymers (GECOs), epichlorohydrin-propylene oxide-allyl glycidyl ether terpolymers, and epichlorohydrin-ethylene oxide-propylene oxide-allyl glycidyl ether tetrapolymers.

Among these, copolymers containing ethylene oxide, that is, ECO and/or GECO, are particularly desirable to adjust the roller resistance value of the transfer roller to a suitable range when used in combination with the diene-based rubber.

Contents of ethylene oxide in both of the above-described copolymers are preferably 30 mol % or more, particularly preferably 50 mol % or more and preferably 80 mol % or less.

Ethylene oxide functions to decrease the roller resistance value of the transfer roller. However, when the content of ethylene oxide is below this range, such a function cannot be sufficiently obtained. Thus, the roller resistance value cannot be sufficiently decreased in some cases.

On the other hand, when the content of ethylene oxide exceeds the above-described range, the crystallization of ethylene oxide is caused and a segment motion of a molecular chain is hindered. Thus, conversely, the roller resistance value tends to increase. Furthermore, there is also concern that the roller main body after crosslinking may become too hard or the viscosity of the rubber composition before crosslinking may increase at the time of heating and melting, which is bad for processability.

The content of epichlorohydrin in an ECO is the remaining amount other than the content of ethylene oxide. In other words, the content of epichlorohydrin is preferably 20 mol % or more and preferably 70 mol % or less, and particularly preferably 50 mol % or less.

Also, the content of allyl glycidyl ether in a GECO is preferably 0.5 mol % or more, particularly preferably 2 mol % or more and preferably 10 mol % or less, and particularly preferably 5 mol % or less.

Allyl glycidyl ether itself functions to secure a free volume as a side chain, thereby minimizing the crystallization of ethylene oxide and reducing the roller resistance value of the transfer roller. However, when the content of allyl glycidyl ether is below this range, there is concern that the roller resistance value of the transfer roller cannot be sufficiently decreased because such a function cannot be sufficiently obtained.

On the other hand, allyl glycidyl ether functions as a crosslinking point at the time of crosslinking a GECO. For this reason, when the content of allyl glycidyl ether exceeds the above-described range, a crosslink density of a GECO is too high and thus a segment motion of a molecular chain is hindered and the roller resistance value tends to increase.

The content of epichlorohydrin in a GECO is the remaining amount other than the content of ethylene oxide and the content of allyl glycidyl ether. In other words, the content of epichlorohydrin is preferably 10 mol % or more, particularly preferably 19.5 mol % or more and preferably 69.5 mol % or less, and particularly preferably 60 mol % or less.

As GECOs, modified copolymers obtained by modifying epichlorohydrin-ethylene oxide copolymers (ECOs) with allyl glycidyl ether are also known in addition to the copolymers in the narrow meaning in which the above-mentioned monomers of three types are copolymerized. In the disclosure, any of these GECOs can be used.

One or two or more of these epichlorohydrin rubbers can be used.

(Blending Ratio)

A blending ratio of epichlorohydrin rubber is preferably 15 parts by mass or more and preferably 38 parts by mass or less with respect to 100 parts by mass of the total amount of rubbers. A blending ratio of a diene-based rubber is the remaining amount other than the epichlorohydrin rubber. In other words, the blending ratio of the diene-based rubber may be set so that the total amount of rubbers is 100 parts by mass when the blending ratio of the epichlorohydrin rubber is set to a predetermined value within the above-described range.

When the blending ratio of the epichlorohydrin rubber is below the above-described range, the roller resistance value of the transfer roller cannot be sufficiently reduced even with the combined use of aluminum silicate in some cases.

On the other hand, when the blending ratio of the epichlorohydrin rubber exceeds the above-described range, as described above, a component derived from the epichlorohydrin rubber transitions to the photoreceptor, the transfer belt, and the like and contaminates these members and accordingly image defects are likely to occur in formed images in some cases.

Also, a relative proportion of the diene-based rubber is small and thus it is impossible to impart the above-mentioned good properties of a rubber due to the combined use of the diene-based rubber to the roller main body in some cases.

On the other hand, when the blending ratio of the epichlorohydrin rubber is set to the above-described range, it is possible to sufficiently reduce the roller resistance value of the transfer roller to a range in which the transfer roller is appropriate as a transfer roller through the combined use of aluminum silicate while minimizing the contamination of the photoreceptor, the transfer belt, and the like. It is also possible to impart the good properties of a rubber to the roller main body.

It should be noted that the blending ratio of the epichlorohydrin rubber is preferably 18 parts by mass or more and preferably 35 parts by mass or less with respect to 100 parts by mass of the total amount of rubbers in the above-described range in consideration of further improving these effects.

<Crosslinking Component>

As crosslinking components, it is desirable to use crosslinking agents configured to crosslink rubbers and crosslinking accelerators configured to promote the crosslinking of rubbers using the crosslinking agents together.

Among these, examples of crosslinking agents include sulfur-based crosslinking agents, thiourea-based crosslinking agents, triazine derivative-based crosslinking agents, peroxide-based crosslinking agents, various monomers, and the like. Particularly, sulfur-based crosslinking agents are desirable.

(Sulfur-Based Crosslinking Agent)

Examples of sulfur-based crosslinking agents include sulfur such as powder sulfur, oil-treated powder sulfur, precipitated sulfur, colloidal sulfur, dispersible sulfur, organic sulfur-containing compounds such as tetramethylthiuram disulfide and N,N-dithiobismorpholine, and the like. Particularly, sulfur is desirable.

A blending ratio of sulfur is preferably 0.5 parts by mass or more and preferably 2 parts by mass or less with respect to 100 parts by mass of the total amount of rubbers in consideration of imparting the above-mentioned good properties of rubbers to the roller main body.

For example, when oil-treated powder sulfur, dispersible sulfur, and the like is used as sulfur, the above-described blending ratio is a proportion of sulfur itself as an active ingredient contained in each.

Also, when an organic-substance-containing sulfur compound is used as a crosslinking agent, it is desirable that a blending ratio thereof be adjusted so that a ratio of sulfur contained in molecules with respect to 100 parts by mass of the total amount of rubbers falls within the above-described range.

(Crosslinking Accelerator)

Examples of crosslinking accelerators configured to promote the crosslinking of rubber using sulfur-based crosslinking agents include accelerators of one type or two or more types such as thiazole-based accelerators, thiuram-based accelerators, sulfenamide-based accelerators, and dithiocarbamate-based accelerators. Among these, it is desirable to use thiuram-based accelerators and thiazole-based accelerators together.

Examples of thiuram-based accelerators include accelerators of one type or two or more types such as tetramethylthiuram monosulfide, tetramethylthiuram disulfide, tetraethylthiuram disulfide, tetrabutylthiuram disulfide, and dipentamethylenethiuram tetrasulfide.

Also, examples of thiazole-based accelerators include accelerators of one type or two or more types such as 2-mercaptobenzothiazole, di-2-benzothiazolyl disulfide, a zinc salt of 2-mercaptobenzothiazole, a cyclohexylamine salt of 2-mercaptobenzothiazole, and 2-(4′-morpholinodithio)benzothiazole.

A blending ratio of a thiuram-based accelerator is preferably 0.3 parts by mass or more and preferably 3 parts by mass or less with respect to 100 parts by mass of the total amount of rubbers in consideration of sufficiently manifesting the effect of promoting the crosslinking of the rubber using the sulfur-based crosslinking agents in the combined use system of the crosslinking accelerators of two types. Furthermore, a blending ratio of the thiazole-based accelerator is preferably 0.3 parts by mass or more and preferably 2 parts by mass or less with respect to 100 parts by mass of the total amount of rubbers.

(Foaming Component)

As foaming components, various foaming agents capable of decomposing due to heating and generating a gas can be used. Furthermore, auxiliary foaming agents functioning to decrease a decomposition temperature of a foaming agent and promote its decomposition may be combined.

(Foaming Agent)

Examples of foaming agents include foaming agents of one type or two or more types such as azodicarbonamide (ADCA), 4,4′-oxybis(benzenesulfonylhydrazide) (OBSH), and N,N-dinitrosopentamethylenetetramine (DPT). Particularly, ADCA is desirable.

A blending ratio of the foaming agent is preferably 1 part by mass or more and preferably 5 parts by mass or less with respect to 100 parts by mass of the total amount of rubbers.

(Auxiliary Foaming Agent)

As auxiliary foaming agents, various auxiliary foaming agents functioning to decrease decomposition temperatures of foaming agents to be combined and promote its decomposition can be used as described above. Examples of auxiliary foaming agents which can be combined with ADCA include urea (H₂NCONH₂)-based auxiliary foaming agents.

A blending ratio of an auxiliary foaming agent can be arbitrarily set in accordance with a type of foaming agent to be combined and is preferably 1 part by mass or more and preferably 5 parts by mass or less with respect to 100 parts by mass of the total amount of rubbers.

(Others)

Various additives may be further blended with the rubber composition if necessary. Examples of additives include acid accepting agents, fillers, and the like.

Among these, acid accepting agents function to prevent a chlorine-based gas generated from epichlorohydrin rubber or the like at the time of crosslinking from remaining in a transfer roller and accordingly from causing crosslinking inhibition, contamination of the photoreceptor, the transfer belt, and the like.

As acid accepting agents, various substances acting as acid acceptors can be used. In addition, among them, hydrotalcites and magsarat having excellent dispersibility are desirable and hydrotalcites are particularly desirable.

Also, when hydrotalcites or the like are used together with magnesium oxide or potassium oxide, it is possible to obtain a higher acid acceptance effect and to more reliably prevent contamination of the photoreceptor, the transfer belt, or the like.

A blending ratio of an acid accepting agent is preferably 0.2 parts by mass or more, particularly preferably 0.5 parts by mass or more and preferably 5 parts by mass or less, and particularly preferably 2 parts by mass or less with respect to 100 parts by mass of the total amount of rubbers.

Examples of fillers include fillers of one type or two or more of types such as zinc oxide, silica, carbon black, talc, calcium carbonate, magnesium carbonate, and aluminum hydroxide.

It is possible to improve a mechanical strength and the like of the transfer roller by blending a filler.

It is also possible to impart electron conductivity to the transfer roller using conductive carbon black as a filler.

As conductive carbon black, HAF is desirable. Since HAF can be uniformly dispersed in a rubber composition, it is possible to impart electron conductivity to a transfer roller as uniformly as possible.

A blending ratio of conductive carbon black is preferably 5 parts by mass or more and preferably 20 parts by mass or less with respect to 100 parts by mass of the total amount of rubbers.

As additives, various additives such as auxiliary crosslinking promotion agents, deterioration preventing agents, scorch preventing agents, plasticizers, lubricants, pigments, antistatic agents, flame retardants, neutralizing agents, nucleating agents, and co-crosslinking agents may be further blended at arbitrary ratios.

<<Transfer Roller>>

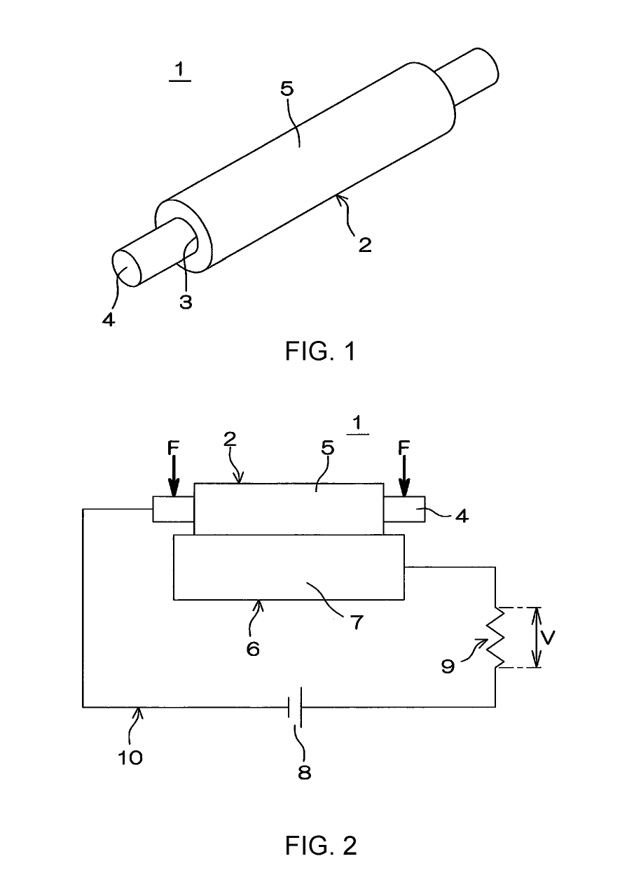

FIG. 1 is a perspective view illustrating an example of an embodiment of a transfer roller according to the disclosure.

Referring to FIG. 1, a transfer roller 1 in this example includes a roller main body 2 which is constituted of a foam with a rubber composition containing the above-described components, is porous, is formed in a single-layer tubular shape, and has a through hole 3 of the roller main body 2 at a center thereof through which a shaft 4 is inserted and fixed.

The shaft 4 is integrally formed of, for example, a metal such as aluminum, an aluminum alloy, and stainless steel.

For example, when the shaft 4 is electrically connected and mechanically fixed to the roller main body 2 with a conductive adhesive therebetween or the shaft 4 having a larger outer diameter than an inner diameter of the through hole 3 is press-fitted into the through hole 3, the shaft 4 is electrically joined and mechanically fixed to the roller main body 2.

As described above, any roller resistance value R (Ω) of the transfer roller 1 that falls within a range in which the transfer roller 1 can be appropriately used as a transfer roller may be adopted. To be specific, roller resistance values R (Ω) measured using the following measurement method under a normal temperature and normal humidity environment of a temperature of 23° C. and a relative humidity of 55% are represented in terms of common logarithm values log R, which are preferably 6.6 or more, particularly preferably 6.8 or more and preferably 8.5 or less, and particularly preferably 7.8 or less.

<Measurement of Roller Resistance Value>

FIG. 2 is a diagram for explaining a method for measuring a roller resistance value of the transfer roller.

Referring to FIGS. 1 and 2, in the measurement method, an aluminum drum 6 which can rotate at a constant rotation speed is prepared and an outer circumferential surface 7 of the prepared aluminum drum 6 is brought into contact with an outer circumferential surface 5 of the roller main body 2 in the transfer roller 1 whose roller resistance value is being measured from above.

A measuring circuit 10 is constituted by connecting a direct current (DC) power supply 8 and a resistor 9 in series between the shaft 4 and the aluminum drum 6 in the transfer roller 1. The DC power supply 8 has a (−) side connected to the shaft 4 and a (+) side connected to the resistor 9. A resistance valuer of the resistor 9 is set to 100Ω.

Subsequently, the aluminum drum 6 is rotated at 300 rpm in a state in which a 500 g load F is applied to both ends of the shaft 4 and the roller main body 2 is brought into close contact with the aluminum drum 6. Moreover, an applied voltage E of a 1000 V direct current is applied between the transfer roller 1 and the aluminum drum 6 from the DC power supply 8 while it continues to rotate and a detection voltage V applied to the resistor 9 is measured after 30 seconds.

From the measured detection voltage V and the applied voltage E(=1000 V), the roller resistance value R of the transfer roller 1 is basically obtained by Expression (i′):

R=r*E/V−r (i′).

Here, the term of −r in Expression (i′) can be regarded as a minute term. Thus, in the disclosure, a value obtained using Expression (i):

R=r*E/V (i),

is regarded as the roller resistance value of the transfer roller 1.

Also, a rubber hardness of the roller main body 2 is preferably 18 or more and preferably 45 or less expressed as Asker C type hardness. When Asker C type hardness is below this range, the strength of the roller main body is insufficient and thus permanent settling or the like is likely to occur in some cases. On the other hand, when Asker C type hardness exceeds the above-described range, the roller main body is too hard and thus the roller main body may not have appropriate flexibility for the roller main body to be appropriately used as a transfer roller in some cases.

Note that Asker C type hardness of the roller main body 2 is expressed as a value measured through the following method using a Type C hardness tester (Asker Rubber Hardness Tester C type manufactured by KOBUNSHI KEIKI CO., LTD.) compliant with The Society of Rubber Industry, Japan Standard SRIS0101 “Physical testing methods for expanded rubber” applied in Annex 2 of Japanese Industrial Standard JIS K7312₋₁₉₉₆ “Physical testing methods for molded products of thermosetting polyurethane elastomers.”

<Measurement of Asker C Type Hardness>

Asker C type hardness is measured by pressing a pushing needle of the type C hardness tester against a central portion of the roller main body 2 in a state in which both ends of the shaft 4 inserted and fixed into the roller main body 2 are fixed to a support base and applying a load of 4.9 N (≈500 gf) to the pushing needle.

<Manufacturing of Transfer Roller>

When the transfer roller 1 according to the disclosure is manufactured, first, a rubber composition constituted of the above-mentioned components is extrusion-molded in a tubular shape using an extrusion machine, is cut to have a predetermined length, and then is foamed and crosslinked by being subjected to pressurizing and heating using pressurized steam in a vulcanization can.

Subsequently, the foamed and crosslinked tubular body is heated using an oven or the like, is subjected to secondary crosslinking, is cooled, and then is polished to have a predetermined outer diameter to form the roller main body 2.

The shaft 4 can be inserted and fixed into the through hole 3 at an arbitrary time before the tubular body has been polished and after the tubular body has been cut.

Here, after the cutting, first, it is desirable to perform polishing and secondary crosslinking in a state in which the shaft 4 is inserted into the through hole 3. Thus, it is possible to minimize warpage, deformation, or the like of the tubular body due to the expansion and shrinkage during the secondary crosslinking. Furthermore, it is possible to improve the workability of polishing by performing the polishing with rotation about the shaft 4 and to minimize the variation of an outer circumferential surface 5.

As described above, the shaft 4 is inserted into the through hole 3 of the tubular body before the secondary crosslinking with a conductive adhesive, particularly, a conductive thermosetting adhesive, therebetween and then the secondary crosslinking is performed or the shaft 4 having an outer diameter larger than a diameter of the through hole 3 may be press-fitted into the through hole 3.

In the former case, the tubular body is subjected to the secondary crosslinking through heating in the oven and at the same time the thermosetting adhesive is cured so that the shaft 4 is electrically joined and mechanically fixed to the roller main body 2. Furthermore, in the latter case, electrical joining and mechanical fixing are completed simultaneously with press-fitting. These two cases may be used together.

<<Image Forming Apparatus>>

An image forming apparatus according to the disclosure is characterized by incorporating the transfer roller 1 according to the disclosure. Examples of the image forming apparatus according to the disclosure include various image forming apparatuses using electrophotographic methods such as laser printers, electrostatic copying machines, plain paper facsimile machines, and multifunction machines thereof.

### EXAMPLES

The disclosure will be further described below on the basis of Examples and Comparative Examples, but the constitution of the disclosure is not necessarily limited to these Examples and Comparative Examples.

### Example 1

(Rubber Composition)

As a rubber, 35 parts by mass of GECO [HYDRIN (registered trademark) T3108 manufactured by ZEON CORPORATION] and 65 parts by mass of NBR [JSR (registered trademark) N250SL manufactured by JSR, a low nitrile NBR, containing 20% acrylonitrile, non-oil-extended] were blended.

First, components other than a crosslinking component among components illustrated in Table 1 were added and kneaded while 100 parts by mass of the total amount of these rubbers were being masticated using a Banbury mixer, the crosslinking component was added and kneaded, and a rubber composition was prepared.

TABLE 1

| Component | Parts by mass |
|---|---|
| Clay | 5.0 |
| Foaming agent | 4.0 |
| Auxiliary foaming agent | 4.0 |
| Filler | 10.0 |
| Acid accepting agent | 1.5 |
| Crosslinking agent | 1.6 |
| Crosslinking accelerator DM | 1.6 |
| Crosslinking accelerator TS | 2.0 |

The components in Table 1 are as follows. The expression “parts by mass” in Table 1 is parts by mass with respect to 100 parts by mass of the total amount of rubbers.

Clay: Containing aluminum silicate at 86 mass % [ST-CROWN manufactured by SHIRAISHI CALCIUM KAISHA, LTD.]

Foaming agent: ADCA [Product Name PINIFOL AC#3 manufactured by EIWA CHEMICAL IND. CO.]

Auxiliary foaming agent: Urea-based auxiliary foaming agent [Product Name CELL PASTE 101 manufactured by EIWA CHEMICAL IND. CO., LTD.]

Filler: Carbon black HAF [Product Name SEAST 3 manufactured by Tokai Carbon Co., Ltd.]

Acid accepting agent: hydrotalcites [DHT-4A-2 manufactured by Kyowa Chemical Industry Co., Ltd.]

Crosslinking agent: Powder sulfur [manufactured by Tsurumi Chemical Industry Co., Ltd.]

Crosslinking accelerator DM: Di-2-benzothiaxyl disulfide [Product Name SUNS1 NE MBTS manufactured by Shandong Shanxian Chemical Co. Ltd.]

Crosslinking accelerator TS: tetramethylthiuram disulfide [SANCELER (registered trademark) TS manufactured by SANSHIN CHEMICAL INDUSTRY CO., LTD.]

A blending ratio of aluminum silicate was 4.3 parts by mass with respect to 100 parts by mass of the total amount of rubbers.

(Transfer Roller)

The prepared rubber composition was supplied to an extrusion machine, extrusion-molded in a tubular shape having an outer diameter of φ 10 mm and an inner diameter of φ 3.O mm, cut to have a predetermined length, and attached to a temporary shaft for crosslinking having an outer diameter of φ 2.2 mm.

Subsequently, a tubular body was subjected to pressurizing and heating using pressurized steam in a vulcanization can at 120° C.*10 minutes and then at 160° C.*20 minutes, the tubular body was foamed using a gas generated due to the decomposition of the foaming agent, and the rubber was crosslinked.

Subsequently, the tubular body was reattached to the shaft 4 having an outer diameter of φ 5 mm whose outer circumferential surface is coated with a conductive thermosetting adhesive, secondary-crosslinked by being subjected to heating at 160° C.*60 minutes in an oven, and electrically joined and mechanically fixed to the shaft 4 by curing the thermosetting adhesive.

Moreover, when both ends of the tubular body were shaped and then the outer circumferential surface 5 thereof was subjected to traverse grinding using a cylindrical grinding machine, the roller main body 2 was formed by finishing its outer diameter to φ 12.5 mm (tolerance±0.1 mm) and the transfer roller 1 was prepared.

### Example 2

A rubber composition was prepared in the same manner as in Example 1 except that a blending ratio of GECO was 30 parts by mass, a blending ratio of NBR was 70 parts by mass, a blending ratio of clay was 25 parts by mass, and a transfer roller 1 was produced.

A blending ratio of aluminum silicate was 21.5 parts by mass with respect to 100 parts by mass of the total amount of rubbers.

### Example 3

A rubber composition was prepared in the same manner as in Example 1 except that a blending ratio of GECO was 18 parts by mass, a blending ratio of NBR was 82 parts by mass, a blending ratio of clay was 50 parts by mass, and a transfer roller 1 was produced.

A blending ratio of aluminum silicate was 43.0 parts by mass with respect to 100 parts by mass of the total amount of rubbers.

### Example 4

A rubber composition was prepared in the same manner as in Example 2 except that a blending ratio of NBR was 40 parts by mass, 30 parts by mass of SBR [SUMITOMO SBR1502 manufactured by Sumitomo Chemical Co., Ltd., non-oil-extended] was further blended, and a transfer roller 1 was produced.

A blending ratio of aluminum silicate was 21.5 parts by mass with respect to 100 parts by mass of the total amount of rubbers.

### Example 5

A rubber composition was prepared in the same manner as in Example 2 except that a blending ratio of NBR was 40 parts by mass, 30 parts by mass of BR [JSR BRO1 manufactured by JSR, non-oil-extended] was further blended, and a transfer roller 1 was produced.

A blending ratio of aluminum silicate was 21.5 parts by mass with respect to 100 parts by mass of the total amount of rubbers.

### Example 6

A rubber composition was prepared in the same manner as in Example 2 except that a blending ratio of NBR was 40 parts by mass, 30 parts by mass of SBR [SUMITOMO SBR1502 manufactured by Sumitomo Chemical Co., Ltd., non-oil-extended] was further blended, a blending ratio of GECO was 20 parts by mass, a blending ratio of clay was 10 parts by mass, and a transfer roller 1 was produced.

A blending ratio of aluminum silicate was 8.6 parts by mass with respect to 100 parts by mass of the total amount of rubbers.

### Comparative Example 1

A rubber composition was prepared in the same manner as in Example 1 except that a blending ratio of GECO was 40 parts by mass, a blending ratio of NBR was 60 parts by mass, a blending ratio of clay was 2 parts by mass, and a transfer roller 1 was produced.

A blending ratio of aluminum silicate was 1.72 parts by mass with respect to 100 parts by mass of the total amount of rubbers.

### Comparative Example 2

A rubber composition was prepared in the same manner as in Example 1 except that a blending ratio of GECO was 10 parts by mass, a blending ratio of NBR was 90 parts by mass, a blending ratio of clay was 70 parts by mass, and a transfer roller 1 was produced.

A blending ratio of aluminum silicate was 60.2 parts by mass with respect to 100 parts by mass of the total amount of rubbers.

### Conventional Example 1

A rubber composition was prepared in the same manner as in Example 1 except that a blending ratio of GECO was 40 parts by mass, a blending ratio of NBR was 60 parts by mass, clay was not blended, and a transfer roller 1 was produced.

<Measurement and Evaluation of Roller Resistance Value>

Roller resistance values R (Ω) in the transfer rollers 1 produced in the examples, the comparative examples, and the conventional example under a normal temperature and normal humidity environment of a temperature of 23° C. and a relative humidity of 55% were measured using the above-mentioned measurement method. Moreover, the measured roller resistance values R (Ω) were represented by common logarithm values log R, a transfer roller having a roller resistance value which was 6.6 or more and 8.5 or less was evaluated to be good (◯), a transfer roller having a roller resistance value which was 6.8 or more and 7.8 or less was evaluated to be particularly good (\textcircled{∘}), and a transfer roller having a roller resistance value which was less than 6.6 or a roller resistance value which exceeded 8.5 was evaluated to be poor (×).

<Evaluation of contamination>

The transfer rollers 1 produced in the examples, the comparative examples, and the conventional example were left to stand under an environment of a temperature of 40° C. and a relative humidity of 90% in a state in which the transfer rollers 1 produced in the examples, the comparative examples, and the conventional example were brought into pressure contact with the photoreceptor taken from a laser printer [HP Laser Jet P1606 do manufactured by HP Development Company, L.P.]. Loads of press-contact were 500 g per side of the shaft and 1 kg on both sides thereof.

After releasing the pressure contact one week later and incorporating the photoreceptors in the above-described laser printer again, 10 images of black solid images were formed continuously, and the presence or absence of contamination was evaluated in accordance with the following criteria.

\textcircled{∘}: No abnormality was found in 10 images.

◯: A slight white spot was seen in the image from the first sheet to the fourth sheet, but no white spot was seen from the fifth sheet.

×: Severe white spots were seen in the image from the first sheet and were seen in the sixth and subsequent sheets.

<Measurement and Evaluation of Asker C Type Hardness>

Asker C type hardness of the transfer rollers 1 produced in the examples, the comparative examples, and the conventional example were measured using the above-mentioned measurement method. Moreover, a transfer roller 1 having Asker C type hardness which was 18 or more and 45 or less was evaluated to be good (◯) and a transfer roller 1 having Asker C type hardness which was less than 18 or Asker C type hardness which exceeded 45 was evaluated to be poor (×).

The above-described results are illustrated in Tables 2 and 3.

TABLE 2

| | | | Example 1 | Example 2 | Example 3 | Example 4 | Example 5 | Example 6 |
|---|---|---|---|---|---|---|---|---|
| Parts by | NBR | | 65 | 70 | 82 | 40 | 40 | 40 |
| mass | SBR | | — | — | — | 30 | — | 30 |
| | BR | | — | — | — | — | 30 | — |
| | GECO | | 65 | 30 | 18 | 30 | 30 | 20 |
| | Clay | | 5 | 25 | 50 | 25 | 25 | 10 |
| | (aluminum | | (4.3) | (21.5) | (43.0) | (21.5) | (21.5) | (8.6) |
| | silicate) | | | | | | | |
| Evaluation | logR | Numerical | 7.8 | 7.1 | 6.8 | 6.9 | 7.0 | 8.5 |
| | | value | | | | | | |
| | | Evaluation | ⊚ | ⊚ | ⊚ | ⊚ | ⊚ | ◯ |

| | | | | | | |
|---|---|---|---|---|---|---|
| Contamination | ⊚ | ⊚ | ⊚ | ⊚ | ⊚ | ⊚ |
| Asker C type | ◯ | ◯ | ◯ | ◯ | ◯ | ◯ |
| hardness | | | | | | |

TABLE 3

| | | | Comparative | Comparative | Conventional |
|---|---|---|---|---|---|
| | | | Example 1 | Example 2 | Example 1 |
| Parts by | NBR | | 60 | 90 | 60 |
| mass | SBR | | — | — | — |
| | BR | | — | — | — |
| | GECO | | 40 | 10 | 40 |
| | Clay | | 2 | 70 | — |
| | (aluminum | | (1.7) | (60.2) | |
| | silicate) | | | | |
| Evaluation | logR | Numerical | 7.9 | 6.6 | 7.9 |
| | | value | | | |
| | | Evaluation | ◯ | ◯ | ◯ |

| | | | |
|---|---|---|---|
| Contamination | X | ⊚ | X |
| Asker C type | ◯ | X | ◯ |
| hardness | | | |

From the results of Examples 1 to 6 and Conventional Example 1 in Tables 2 and 3, it was found that it is possible to decrease the roller resistance values of the transfer rollers without increasing a blending ratio of epichlorohydrin rubber when aluminum silicate is blended with the rubber composition.

Here, it was found from the results of Examples 1 and 6 and Comparative Examples 1 and 2 that, in order to reduce the roller resistance values of the transfer rollers without increasing the blending ratio of epichlorohydrin rubber while maintaining excellent flexibility and the like of the roller main body, the blending ratio of aluminum silicate needs to be 3 parts by mass or more and 50 parts by mass or less with respect to 100 parts by mass of the total amount of rubbers. Furthermore, it was also found that, in order to prevent the contamination of the photoreceptor or the like, the blending ratio of epichlorohydrin rubber is preferably 38 parts by mass or less with respect to 100 parts by mass of the total amount of rubbers.

Also, it was found from the results of Examples 1 to 6 that the blending ratio of aluminum silicate is preferably 45 parts by mass or less with respect to 100 parts by mass of the total amount of rubbers in consideration of further increasing the above-described effects.

1. A rubber composition, comprising:
at least one selected from the group consisting of acrylonitrile butadiene-based rubbers, styrene butadiene-based rubbers, and butadiene-based rubbers;
a rubber including epichlorohydrin rubber;
a crosslinking component that crosslinks the rubbers;
a foaming component that foams the rubbers; and
3 parts by mass or more and 50 parts by mass or less of aluminum silicate with respect to 100 parts by mass of a total amount of rubbers.

2. The rubber composition according to claim 1, wherein a blending ratio of the epichlorohydrin rubber is 38 parts by mass or less with respect to 100 parts by mass of the total amount of rubbers.

3. A transfer roller comprising a roller main body including the rubber composition according to claim 1.

4. The transfer roller according to claim 3, comprising:
the roller main body which is constituted of the rubber composition, is porous and is a single-layer,
wherein Asker C hardness of the roller main body is 18 or more and 45 or less.

5. The transfer roller according to claim 3, comprising:
the roller main body which is constituted of the rubber composition, is porous and is a single-layer,
wherein a roller resistance value (Ω) is represented by a common logarithm value log Ω and is 6.8 or more and 7.8 or less.

6. An image forming apparatus comprising the transfer roller according to claim 3.

7. A transfer roller comprising a roller main body including the rubber composition according to claim 2.

8. The transfer roller according to claim 4, comprising:
the roller main body which is constituted of the rubber composition, is porous and is a single-layer,
wherein a roller resistance value (Ω) is represented by a common logarithm value log Ω and is 6.8 or more and 7.8 or less.

9. An image foil ling apparatus comprising the transfer roller according to claim 4.

10. An image forming apparatus comprising the transfer roller according to claim 5.
